(19) United States
(12) Patent Application Publication
(10) Pub. No.: US 2016/0223818 A1
(43) Pub. Date: Aug. 4, 2016

(54) IMAGE DISPLAY DEVICE

(71) Applicant: Panasonic Intellectual Property Management Co., Ltd., Osaka (JP)

(72) Inventors: Kei TASAKA, Osaka (JP); Katsuo SAIGO, Hyogo (JP); Hiroshi MITANI, Osaka (JP)

(21) Appl. No.: 15/012,119

(22) Filed: Feb. 1, 2016

(30) Foreign Application Priority Data
Feb. 4, 2015 (JP) 2015-020625
Dec. 2, 2015 (JP) 2015-235425

(51) Int. Cl. G02B 27/01; G02B 1/11

(52) U.S. Cl. CPC G02B 27/0172; G02B 27/0176; G02B 1/11; G02B 2027/013; G02B 2027/0161; G02B 2027/0194; G02B 2027/012

(57) ABSTRACT

An image display device of the present disclosure includes a display element configured to project image light based on an input image signal, a concave mirror configured to transmit external environment light incident from outside and to reflect the image light from the display element, and a housing configured to retain the display element and the concave mirror in a predetermined position relation, and having an opening portion for allowing the external environment light and the image light to pass therethrough. The concave mirror and the display element are mounted on the housing in the predetermined position relation in which the concave mirror guides the reflected light of the image light to a fixed direction toward the opening portion.

### BACKGROUND

1. Technical Field

The present disclosure relates to a transmission type image display device to be mounted in front of the face or on the head of an observer to show an image to the observer.

2. Description of the Related Art

Unexamined Japanese Patent Publication No. 2003-279883 discloses a display device provided with a display element and a transmission-type concave mirror. The display element, with a display surface facing the front side, is hung at a position which is below a bill of a cap and is in front of the forehead of an observer and above a position of the pupil of the observer. The transmission-type concave mirror, with a reflection surface facing toward the pupil of the observer, is hung on a lower surface of the bill at a position ahead of the display element. According to the conventional display device, the observer may simultaneously observe image light of the display element reflected from the concave mirror and external environment light transmitted through the transmission-type concave mirror.

### SUMMARY

An image display device of the present disclosure includes a display element configured to project image light based on an input image signal, a concave mirror configured to transmit external environment light incident from the outside and to reflect the image light from the display element, and a housing configured to retain the display element and the concave mirror in a predetermined optical position relation, and having an opening portion for allowing the external environment light and the image light to pass therethrough. The concave mirror and the display element are mounted on the housing in a predetermined position relation in which the concave mirror guides the reflected light of the image light in a fixed direction toward the opening portion.

### BRIEF DESCRIPTION OF DRAWINGS

FIG. 1 is a schematic diagram illustrating a concept of a configuration of an image display device according to a first exemplary embodiment;

FIG. 2 is a diagram illustrating a wavelength characteristic of an LED light source included in a display element;

FIG. 3 is a diagram illustrating a reflectance characteristic relative to a wavelength, of a wavelength selective film;

FIG. 4 is a diagram illustrating angular dependence of reflectance on an incident angle, of the wavelength selective film;

FIG. 5A is a perspective view of a concrete example of the image display device viewed from an oblique front side;

FIG. 5B is a perspective view of the concrete example of the image display device viewed from an oblique rear side;

FIG. 6A is a top view of the image display device;

FIG. 6B is a front view of the image display device;

FIG. 7 is a diagram illustrating an internal configuration of the image display device illustrated in FIGS. 5A to 6B;

FIG. 8 is a diagram describing a spectacle frame type mounting tool mounted with the image display device;

FIG. 9A is a diagram of a neck band type mounting tool mounted with the image display device, viewed from an oblique front side;

FIG. 9B is a diagram of the neck band type mounting tool in FIG. 9A, viewed from an oblique rear side; and

FIG. 10 is a diagram describing a helmet mounted with the image display device.

### DETAILED DESCRIPTION

According to a conventional image display device, an inappropriate state of a reflection angle of a concave mirror reduces reflected light from a display element and therefore lightens a displayed image (brightness of the displayed image becomes low). Additionally, when the reflection angle deviates from a sweet spot, distortion caused by the concave mirror becomes large. Accordingly, it is necessary to align the concave mirror at an optimum position in consideration of the brightness of the image and the distortion.

In the conventional image display device, in order to perform the alignment, a user needs to adjust a tilt angle of a rotary mechanism disposed in the concave mirror so as to orient the reflected light of the display element toward his or her pupil. Additionally, since the concave mirror has a focal length, it is necessary to appropriately adjust a distance between the display element and the concave mirror. The tilt angle and the distance in this case are linked with each other. Hence, when one of the tilt angle and the distance is moved, the other is also moved in a linked manner. Therefore, the user needs to find the optimum position by adjusting the tilt angle and the distance in turns.

However, it is extremely complicated and troublesome for the user to simultaneously perform those two adjustments. In particular, it is extremely difficult to align the concave mirror at the optimum position, because a position of the displayed image largely depends on a rotation angle of the concave mirror.

The present disclosure provides an image display device requiring no positional adjustment of an optical element (display element) by a user.

Hereinafter, exemplary embodiments will be described with reference to accompanying drawings as needed. However, unnecessarily detailed description may be omitted. For example, detailed description of already well-known matters and repetition of substantially the same configuration may be omitted. All of such omissions are intended to facilitate understanding by those skilled in the art by preventing the following description from becoming unnecessarily redundant.

Moreover, the inventors provide the accompanying drawings and the following description for those skilled in the art to fully understand the present disclosure, and do not intend to limit the subject matter described in the claims by the accompanying drawings and the following description.

### First Exemplary Embodiment

Hereinafter, a first exemplary embodiment is described with reference to the accompanying drawings.

[1-1. Configuration]

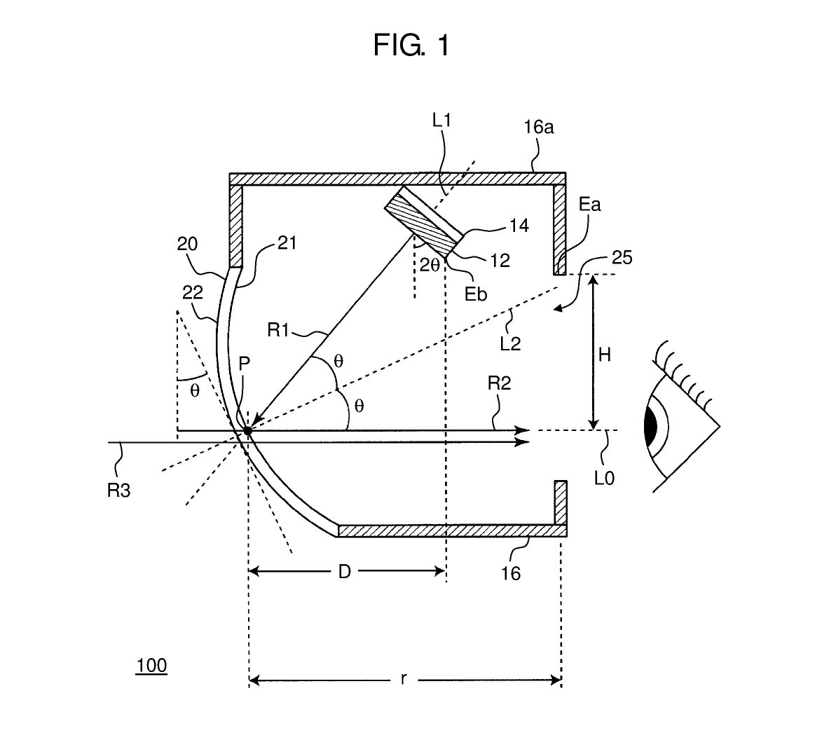

FIG. 1 is a schematic diagram illustrating a concept of a configuration of a transmission type image display device according to the first exemplary embodiment. Image display device 100 receives an image signal from an external image signal generating device and displays an image according to the input image signal. Image display device 100 includes display element 12, drive circuit 14, transmission-type concave mirror 20, and housing 16.

Display element 12 is a display device configured to generate image light, and is configured with, for example, a liquid crystal display element. Drive circuit 14 is a circuit configured to drive display element 12 based on the image signal from the external image signal generating device (not illustrated).

Transmission-type concave mirror (hereinafter, referred to as a “concave mirror”) 20 has optical characteristics which transmit part of external environment light R3 incident from the outside of image display device 100, and reflect part of external environment light R3. Concave mirror 20 has a lens shape having a concave surface and a convex surface. A concave surface side of the mirror is applied with wavelength selective film 21 having high reflectance to a specific wavelength, and a convex surface side of the mirror is applied with anti-reflection coating film 22. Concave mirror 20 transmits external environment light R3 incident from the convex surface side, and reflects image light R1 sent from display element 12 and incident from the concave surface side. Concave mirror 20 is subjected to aspheric surface processing so as not to cause astigmatism in horizontal and vertical directions.

Housing 16 is a member for accommodating display element 12, drive circuit 14, and concave mirror 20 therein. Display element 12 and drive circuit 14 enclosed in an enclosure (not illustrated in FIG. 1) are mounted on housing 16 via the enclosure. Concave mirror 20 is mounted on a front opening portion of housing 16. In the present exemplary embodiment, housing 16 is formed of an opaque material. However, housing 16 may be formed of a transparent material such as acryl resin.

Moreover, optical window 25 is disposed on a rear surface of housing 16. Optical window 25 is a window through which a user visually recognizes an image from display element 12 together with a scene of external environment. To configure optical window 25, a member which transmits light is mounted on opening portion disposed on the rear surface of housing 16 (not illustrated in FIG. 1). However, optical window 25 may be configured with only the opening portion. Optical window 25 is preferably aligned at a position spaced apart from concave mirror 20 by a focal length of concave mirror 20.

Housing 16 configured as described above retains concave mirror 20 and display element 12 at a predetermined position for obtaining a desired magnification factor and suitable brightness (details will be described later). The user may visually recognize external environment light R3 transmitted through concave mirror 20 from the convex surface side of concave mirror 20 and image light R2 which is sent from display element 12 and is reflected by a surface of a concave surface side of concave mirror 20 at the same time, through optical window 25 disposed on the rear surface of housing 16. Here, the image which is sent from display element 12 and is visually recognized by the user is magnified by concave mirror 20.

[1-2. Operation]

An operation of image display device 100 configured as described above will be described below.

Image display device 100 receives the image signal from the external image signal generating device (not illustrated) through a HDMI cable and the like. The received image signal is sent to drive circuit 14. Drive circuit 14 drives display element 12 based on the received image signal. Display element 12 generates image light R1 composed of R (red), G (green), and B (blue) based on control of drive circuit 14, and projects the generated image light to concave mirror 20. Concave mirror 20 magnifies image light R1 of display element 12 with a magnification determined by a curvature of concave mirror 20, and sends image light R2 of display element 12 to the eye of the user through optical window 25.

At the same time, external environment light R3 incident from the convex surface side of concave mirror 20 is transmitted through concave mirror 20 to be sent to the eye of the user through optical window 25.

Next, an optical function of concave mirror 20 will be described.

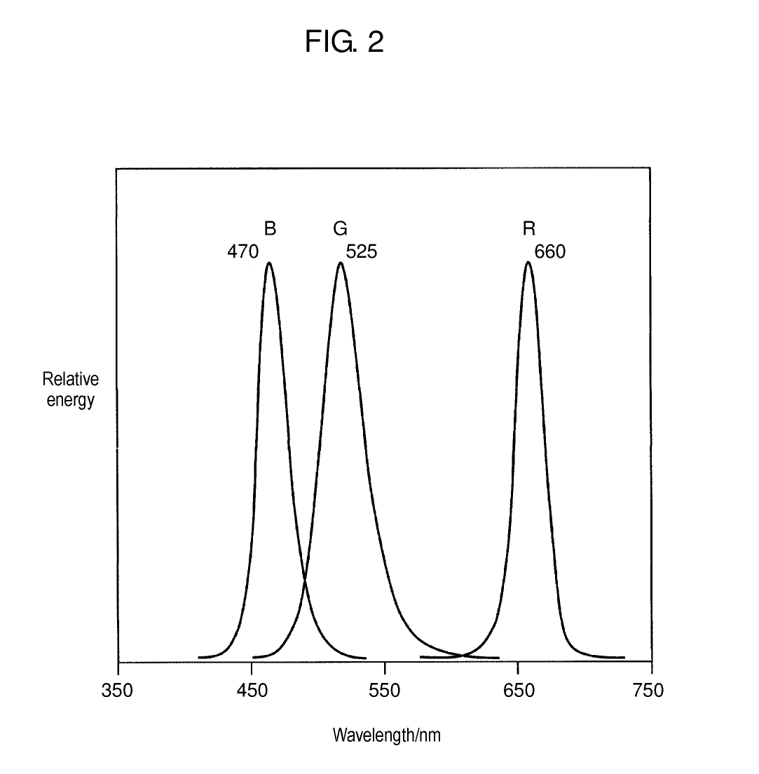

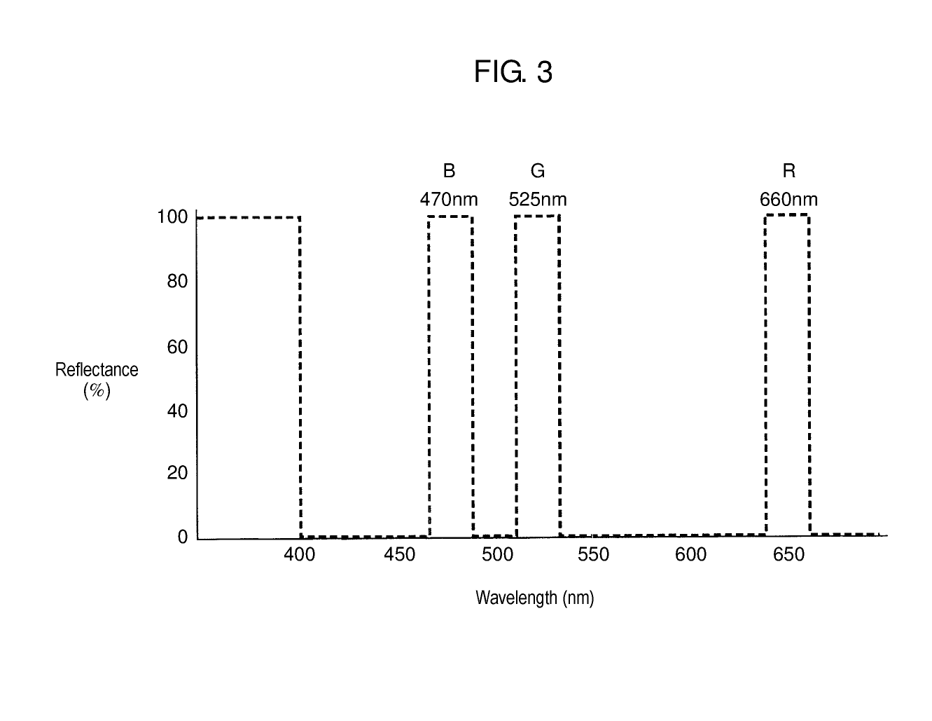

FIG. 2 is a diagram illustrating a wavelength characteristic of an LED light source included in the display element. FIG. 3 is a diagram illustrating a reflectance characteristic relative to a wavelength, of the wavelength selective film. In FIG. 2, a horizontal axis represents a wavelength (nm), and a vertical axis represents relative energy. In FIG. 3, a horizontal axis represents a wavelength (nm), and a vertical axis represents reflectance (%).

The concave surface side of concave mirror 20 is applied with wavelength selective film 21. Wavelength selective film 21 has a characteristic of reflecting only image light R1 of display element 12. As the wavelength selective film, a film having multilayer structure in which metal and the like is deposited on a base material of lens is typically known. In such a wavelength selective film, a reflected wave by a certain layer and a reflected wave by another layer, which configure a composite wave, are mutually strengthened or weakened according to a condition of film formation. The composite wave may enhance reflectance of a specific wavelength. A known method for enhancing the reflectance of the specific wavelength is, for example, to control film thickness (contributes to optical path length) and a refractive index (contributes to refraction across film layers).

Display element 12 of the present exemplary embodiment includes the LED light source configured to emit each color light of RGB. Wavelength selective film 21 applied on concave mirror 20 has high reflectance for each wavelength of RGB of the LED light source. For example, in the case where each wavelength region corresponding to each color light of RGB has a characteristic illustrated in FIG. 2, wavelength selective film 21 having the reflectance characteristic illustrated in FIG. 3 is applied on concave mirror 20. In the example in FIG. 2, the wavelength regions of RGB are respectively a region having a peak at 660 nm, a region having a peak at 525 nm, and a region having a peak at 470 nm. In the example in FIG. 3, wavelength selective film 21 has high reflectance (100%) for each wavelength region of each color light of RGB and has low reflectance (0%) for the other wavelength regions. Moreover, a reflection characteristic of wavelength selective film 21 may be controlled corresponding to a predetermined incident angle, in order to enhance the reflectance by means of the composition of the reflected waves by respective film layers.

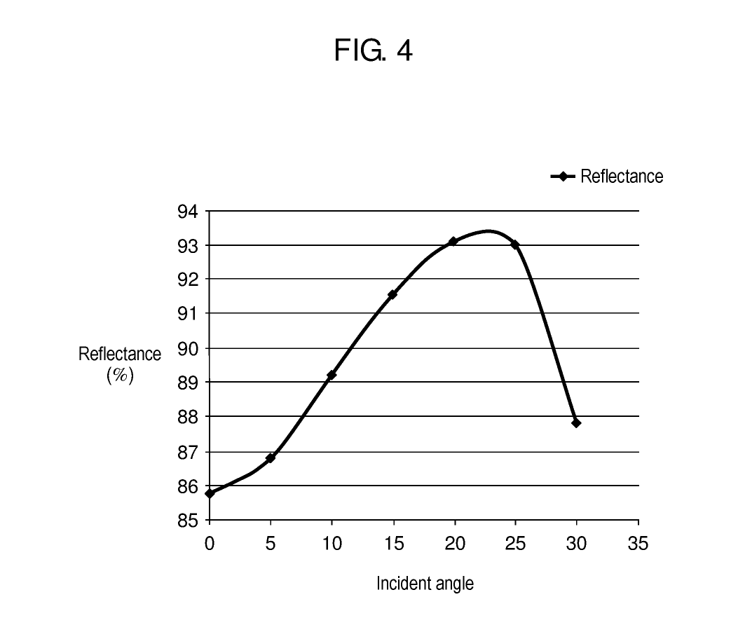

More specifically, the reflectance of wavelength selective film 21 varies corresponding to an incident angle of incident light. FIG. 4 is a diagram illustrating angular dependence of reflectance on an incident angle, of wavelength selective film 21 of the present exemplary embodiment. In FIG. 4, a horizontal axis represents an incident angle (degree), and a vertical axis represents reflectance. In FIG. 4, a horizontal axis represents an incident angle (degree), and a vertical axis represents reflectance (%). As illustrated in FIG. 4, the reflectance of wavelength selective film 21 varies in a mountain shape while having a peak at 22.5 degrees. Accordingly, display element 12 and concave mirror 20 are disposed such that image light R1 from display element 12 enters concave mirror 20 at an incident angle which produces the peak of the reflectance (in the example in FIG. 4, 22.5 degrees), or at an incident angle in the vicinity thereof (for example,22.5 degrees±10 degrees). With this configuration, image light R1 from display element 12 may be efficiently reflected on concave mirror 20. Image display device 100 of the present exemplary embodiment fixes (retains) display element 12 and concave mirror 20 at a predetermined position in housing 16 such that image light R1 from display element 12 enters concave mirror 20 at the aforementioned angle.

Next, housing 16 will be described. As illustrated in FIG. 1, the following description will be made on a state where housing 16 is disposed such that upper surface part 16a of housing 16 is equal to a level. That is, a normal direction of upper surface part 16a of housing 16 is equal to a vertical direction.

Concave mirror 20 is fixed to housing 16 in an inclined manner such that an angle that a plane passing through center (pole) P of concave mirror 20 and contacting with a convex surface side of concave mirror 20 forms with a vertical line becomes θ.

Similarly, display element 12 is fixed to housing 16 in an inclined manner such that an angle that a light-emitting surface of display element 12 forms with a vertical line becomes 2θ. With this configuration, display element 12 is disposed such that normal line L1 passing through a center of the light-emitting surface of display element 12 intersects concave mirror 20 at center P thereof.

By placing concave mirror 20 and display element 12 in this manner, image light R1 projected from the light-emitting surface of display element 12 enters concave mirror 20 at an incident angle θ, and is reflected on concave mirror 20 at an angle of reflection θ in a direction toward optical window 25. Reflected image light R2 advances in a horizontal direction (fixed direction) toward optical window 25, in housing 16. With this configuration, the user perceives image light R2 as light incident from the front. The user may obtain a clear and in-focus image by observing at a substantially focal point of concave mirror 20.

Here, a condition of optical window 25 for preventing display element 12 from interrupting a field of vision of the user will be described with reference to FIG. 1.

By placing concave mirror 20 and display element 12 in the aforementioned manner, both of an angle at which normal line L1 passing through the center of the light-emitting surface of display element 12 intersects mirror axis L2 of concave mirror 20 and an angle that a plane including center P of concave mirror 20 and taking mirror axis L2 of concave mirror 20 as a normal line of the plane forms with a vertical line become θ. Here, in image display device 100, a distance from upper end Ea of optical window 25 to horizontal line L0 passing through center P of concave mirror 20 is denoted by H. Horizontal line L0 is, in other words, a horizontal line which coincides with a light path of light R2 emitted from the center of the light-emitting surface of display element 12 and reflected at center P of concave mirror 20. A distance between a horizontal position of center P of concave mirror 20 and a horizontal position of lowermost end Eb of display element 12 is denoted by D. In this case, distance H is set so as to satisfy the following formula.

H ≦D·tan θ (1)

Distance H affects optical window 25 in size and in position of the upper end thereof. A configuration of optical window 25, setting distance H so as to satisfy the condition of the above formula (1), allows a part of display element 12 to prevent from appearing in the field of vision of the user.

Due to the reflectance characteristic of wavelength selective film 21, the brightness of reflected light R2 of the image light from display element 12 varies according to the incident angle θ. Furthermore, a focusing state and the image magnification factor exerted by concave mirror 20 vary according to distance D. That is, the incident angle is determined so as to improve the brightness of the image which is visually recognized by the user at optical window 25 as much as possible. In addition, distance D is determined such that the image from display element 12 is focused in the vicinity of optical window 25, and such that a desired magnification factor is obtained. Each of concave mirror 20 and display element 12 is fixed to housing 16 at a predetermined position with a predetermined orientation so as to realize the angle θ and distance D, which are determined in the above manner. By fixing concave mirror 20 and display element 12 to housing 16 in such a manner, alignment of concave mirror 20 and display element 12 by the user becomes unnecessary.

In this example, since a whole body of housing 16 is formed of the opaque material, distance H is defined as a distance from horizontal line L0 to upper end Ea of optical window 25. However, when housing 16 is formed of the transparent material, distance H may be a distance from horizontal line L0 to lowermost end Eb of display element 12.

As described above, wavelength selective film 21 applied on concave surface side of concave mirror 20 has the characteristic depending on the incident angle. Then, by matching or substantially matching the angle which produces the peak of the reflectance of wavelength selective film 21 and the incident angle θ, it becomes possible for the user to observe external environment light R3 and image light R1 (R2) at the same time, in the most suitable state.

Moreover, anti-reflection coating film 22 is applied on the convex surface side of concave mirror 20 to prevent reflection of image light R1 sent from display element 12 on a rear side of the convex surface inside concave mirror 20. With this configuration, part of image light R1 which is transmitted through the concave surface of concave mirror 20 is not reflected on the rear side of the convex surface. This prevents visual recognition of unpleasant double images by the user.

A reflection characteristic of anti-reflection coating film 22 also has angular dependence. Anti-reflection coating film 22 is also adjusted to have a characteristic in which reflectance thereof becomes lowest at an incident angle θ or an angle in the vicinity of the incident angle θ. This characteristic decreases reflection on the convex surface and therefore allows the user to visually recognize only suitable image light, even when a position of the pupil of the user is somewhat deviated.

In the configuration of the present exemplary embodiment, a range of the field of vision in which the user may observe image light R1 without distortion is a range about±10 degrees from a center of a pupil. Therefore, applying anti-reflection coating film 22 having a good anti-reflection characteristic in the range of θ±10 degrees (the reflectance is low in the range) on concave mirror 20 may reduce the double images in practical use. The range of angle to suppress reflection, which is required for anti-reflection coating film 22, depends on an angle of view of image light R1.

[1-3. Concrete Examples]

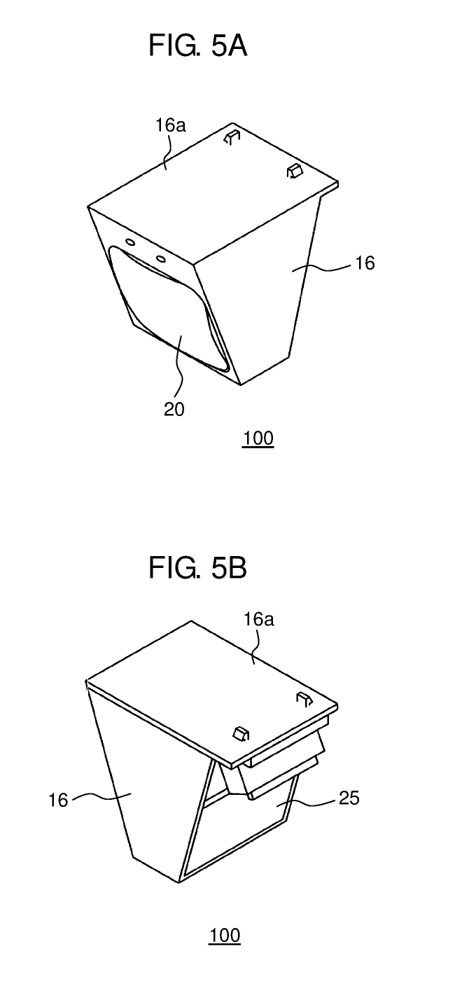

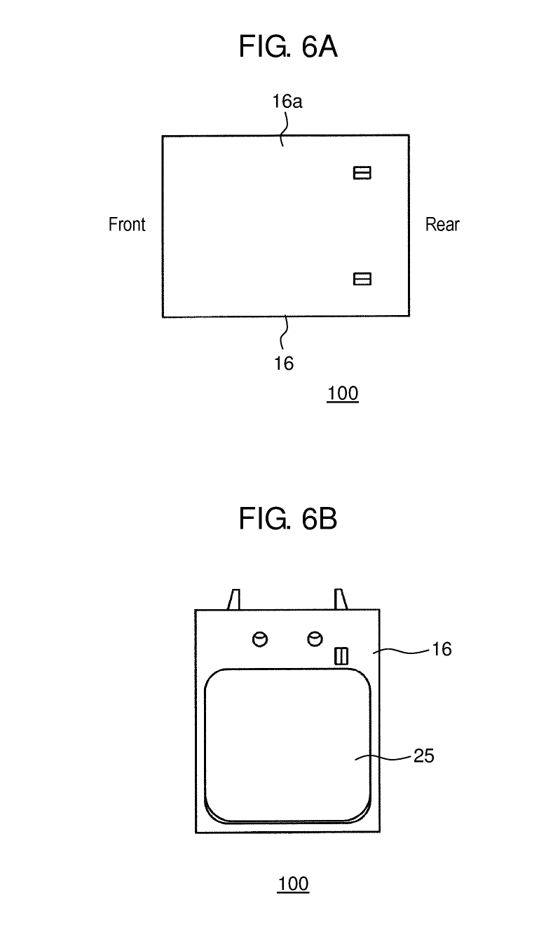

FIGS. 5A to 6B are diagrams each illustrating an appearance of a concrete example of image display device 100 to which the thought of image display device 100 of the present exemplary embodiment is applied. FIG. 5A is a perspective view of image display device 100 viewed from an oblique front side. FIG. 5B is a perspective view of image display device 100 viewed from an oblique rear side. FIG. 6A is a top view of image display device 100 and FIG. 6B is a front view of image display device 100. In housing 16 of image display device 100 illustrated in FIGS. 5A to 6B, only upper surface part 16a is formed of the opaque material and the other parts are formed of the transparent material. Only upper surface part 16a formed of the opaque material may intercept sunlight incident from above. Parts other than upper surface part 16a formed of the transparent material may prevent housing 16 from interrupting the field of vision of the user, resulting in that visibility may be improved. At this time, as described above, distance H is defined as the distance from horizontal line L0 to lowermost end Eb of display element 12. Alternatively, a whole body of the housing may be formed of the transparent material with a focus on ensuring the field of vision.

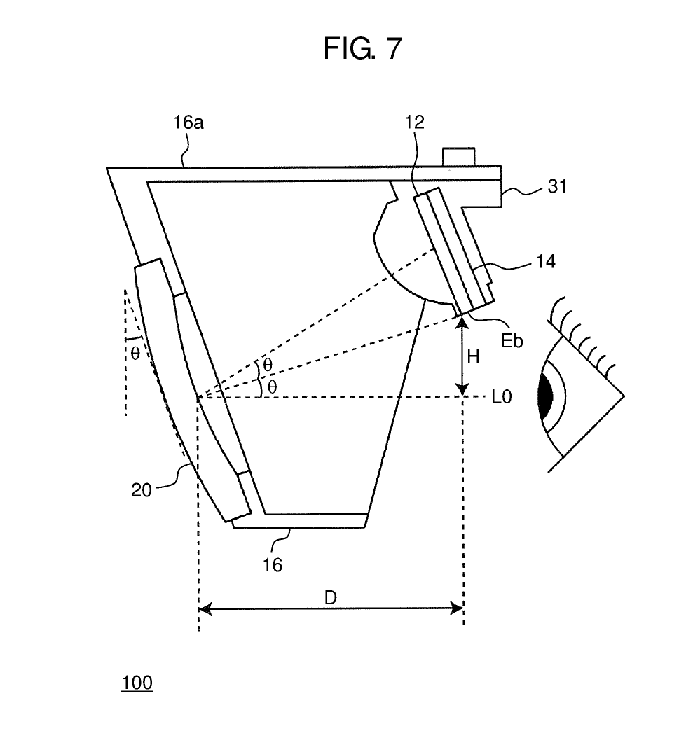

FIG. 7 is a diagram illustrating an internal configuration of image display device 100 illustrated in FIGS. 5A to 6B. Enclosure 31 enclosing display element 12 and drive circuit 14 therein is mounted on upper surface part 16a of housing 16. In this structure, display element 12 and concave mirror 20 are also disposed in housing 16 such that display element 12 and concave mirror 20 satisfy the predetermined optical position relation. Settings of the configuration in FIG. 7 are, for example, θ=20 degrees, D=33 mm, and H=12 mm.

[1-4. Mounting Tools of Image Display Device]

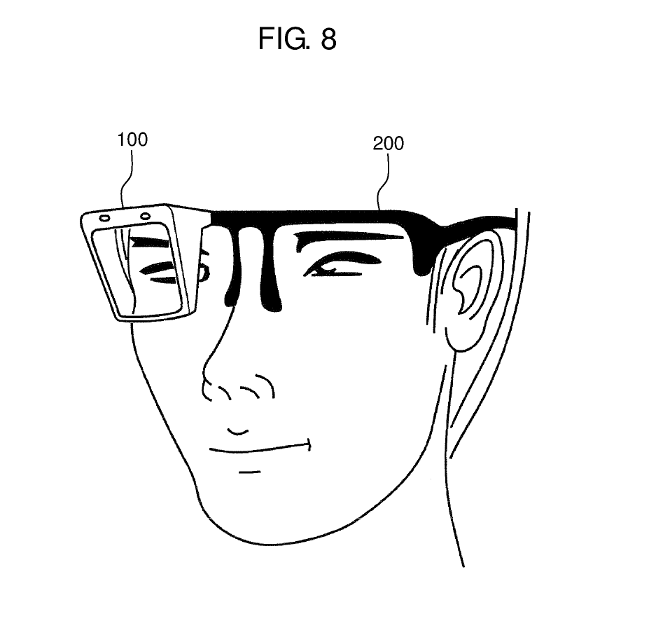

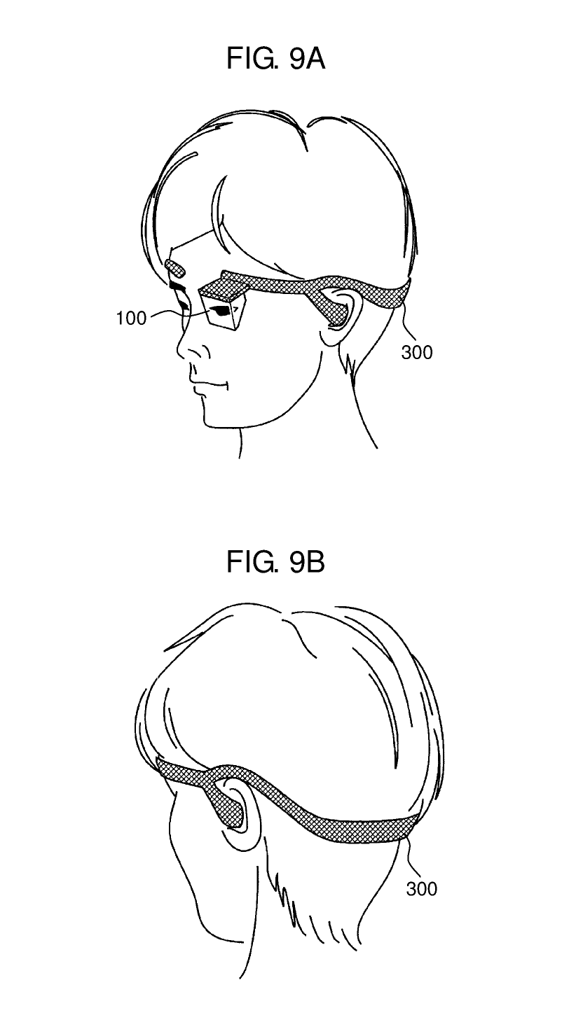

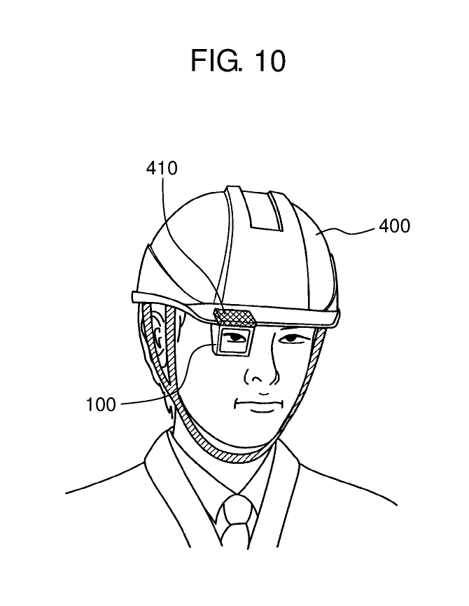

FIGS. 8 to 10 are diagrams describing configurations for mounting aforementioned image display device 100 on the user. FIG. 8 is a diagram describing spectacle frame 200 mounted with image display device 100. Image display device 100 is mounted on a lens portion for one eye in spectacle frame 200. FIG. 9A is a diagram of a neck band type mounting tool 300 mounted with image display device 100 viewed from an oblique front side. FIG. 9B is a diagram of neck band type mounting tool 300 in FIG. 9A viewed from an oblique rear side. As illustrated in FIGS. 9A and 9B, neck band type mounting tool 300 is supported by both ears of the user and is used while being mounted so as to surround the back of the head of the user. FIG. 10 is a diagram describing helmet 400 mounted with image display device 100. Image display device 100 is mounted on helmet 400 via fixture 410 such that image display device 100 is located in front of one eye of the user when helmet 400 is mounted on the user.

[1-5. Effects, etc.]

As described above, in image display device 100 of the present exemplary embodiment, concave mirror 20 and display element 12 are fixed to housing 16 at the predetermined positions, such that the emitted light from image display device 100 has the fixed direction. Thereby the direction of the emitted light from image display device 100 is fixed. Thus a user may suitably observe the external environment light and the image light by only placing his or her pupil in front of optical window 25 of image display device 100, without adjusting the optical arrangement of optical elements such as concave mirror 20 and display element 12.

Specifically, image display device 100 includes display element 12 which projects image light based on the input image signal, concave mirror 20 which transmits external environment light R3 and reflects image light R1 from display element 12, and housing 16 which retains display element 12 and concave mirror 20 in the predetermined position relation and has optical window 25 for allowing external environment light R3 and image light R2 to pass therethrough. Concave mirror 20 and display element 12 are mounted on housing 16 in the predetermined position relation in which concave mirror 20 guides reflected light R2 of the image light to the fixed direction (horizontal direction) toward optical window 25. The predetermined position relation is set according to the reflectance characteristic of the reflection surface of concave mirror 20, for example. Since display element 12 and concave mirror 20 are fixed at the suitably arranged positions by housing 16, a user may observe the in-focus and bright image (the image improved in visibility) in the easy and secure manner, without requiring complicated operations for the user to adjust focus and brightness of the image.

Moreover, a configuration satisfying the above condition (H≦D·tan θ) may prevent the display element from appearing in the field of vision of the user.

Moreover, respective surfaces of concave mirror 20 may be applied with wavelength selective film 21 and anti-reflection coating film 22 respectively. Image light R2 from display element 12 may be efficiently sent to the pupil of the user by using wavelength selective film 21, and further the reflection of the image light inside concave mirror 20 may be reduced by using anti-reflection coating film 22. As a result, the visibility may be improved.

Moreover, in the present exemplary embodiment, the angle difference between the angle producing the highest reflectance in the reflectance characteristic of wavelength selective film 21 (incident angle) and the incident angle of the image light from display element 12 relative to concave mirror 20 is set so as to be in the predetermined range (for example, the range of±10 degrees). Thereby the bright reflected light of the image light may be obtained at the observation position of the user.

The image display device of the present exemplary embodiment allows the user to observe image light R1 from display element 12 and external environment light R3 in a bright state, at the same time.

### Other Exemplary Embodiments

It is known that a diameter of the human pupil is generally 11 mm to 15 mm. Since it is assumed that a center of the pupil of the user is located on horizontal line L0, distance H may be set so as to satisfy the following condition.

H>15 mm/2=7.5 mm (2)

With respect to the formula of distance H related to optical window 25, distance H may be determined so as to satisfy the following formula, when a radius of curvature of concave mirror 20 is denoted by r.

H≦(r/2)·tan θ (1b)

Distance H determined in this manner may also prevent display element 12 or housing 16 from appearing in the field of vision of the user. As a result, a suitable field of vision may be secured.

In the above exemplary embodiment, concave mirror 20 and display element 12 are arranged so as to allow reflected light R2 of image light R1 to advance horizontally, to position the image at the center of the field of vision of the user. However, it is needless to say that the image may be positioned, without degrading image quality, at upper/lower side in the field of vision according to a use, by slightly increasing or decreasing the angles (θ, 2θ) of concave mirror 20 and display element 12.

Thus, the exemplary embodiments are described as examples of the technique in the present disclosure. The accompanying drawings and the detailed description are provided for that purpose.

Therefore, the structural elements shown in the accompanying drawings and described in the detailed description may include not only structural elements that are essential for solving the problem but also other structural elements that are not essential for solving the problem in order to exemplify the aforementioned technique. Hence, these non-essential structural elements should not be immediately recognized as being essential based only on the fact that they are shown in the accompanying drawings and described in the detailed description.

Furthermore, since the purpose of the aforementioned exemplary embodiments is to give an example of the technique in the present disclosure, various modifications, substitutions, additions, omissions, and the like may be implemented within a scope of the claims and equivalents thereto.

The present disclosure is applicable to a head-mounted type image display device. Specifically, the present disclosure is applicable to a head-mounted type display, a head-up display, and the like.

What is claimed is:

1. An image display device comprising:
a display element configured to project image light based on an input image signal;
a concave mirror configured to transmit external environment light incident from outside and to reflect the image light from the display element; and
a housing configured to retain the display element and the concave mirror in a predetermined optical position relation, and having an opening portion for allowing the external environment light and the image light to pass therethrough,
wherein the concave mirror and the display element are mounted on the housing in a predetermined position relation in which the concave mirror guides reflected light of the image light to a fixed direction toward the opening portion.

2. The image display device according to claim 1,
wherein, in a case where the display element and the concave mirror are disposed such that light from a light-emitting surface of the display element enters the concave mirror at an incident angle θ and an advancing direction of the image light incident from the display element and reflected on the concave mirror is set to a horizontal direction,
when a distance between a horizontal position of a center of the concave mirror and a horizontal position of a lower end of the display element is denoted by D, and a distance from an upper end of the opening portion or the lower end of the display element to a straight line which coincides with a light path of the image light reflected at the center of the concave mirror is denoted by H, a relation of a following expression is satisfied.
H≦D·tan θ

3. The image display device according to claim 2, wherein
the concave mirror has an inner surface facing the inside of the housing, the surface being applied with a wavelength selective film, and
the wavelength selective film has a relatively high reflectance characteristic at the incident angle θ and at an angle region in a vicinity of the incident angle θ, in comparison with other angle regions.

4. The image display device according to claim 1,
wherein the concave mirror has an outer surface facing the outside of the housing, the surface being applied with an anti-reflection coating film such that the image light from the display element is not reflected.

5. The image display device according to claim 1,
wherein the housing is formed of a transparent material.

6. The image display device according to claim 1,
wherein the concave mirror has an aspheric surface.
